(19) United States
(12) Patent Application Publication
(10) Pub. No.: US 2012/0162760 A1
(43) Pub. Date: Jun. 28, 2012

(54) Portable Projection Screen

(76) Inventor: Yin-Wen Chen, Hsinchu (TW)

(21) Appl. No.: 12/977,091

(22) Filed: Dec. 23, 2010

(51) Int. Cl. G03B 21/58

(52) U.S. Cl. 359/461

(57) ABSTRACT

A portable projection screen comprises a first frame, a second frame a screen, rolled up within the first frame in a folded state, having a movable end, which is attached to the second frame, and a lever assembly, having two levers which form a shape like the letter X (or double X) with fixed and glidable ends, supporting the second frame in an unfolded state and being accommodated in the first frame in the folded state for a minimized volume and easy portability.

### FIELD OF THE INVENTION

The present invention relates to a portable projection screen, particularly to a portable projection screen with a foldable frame for easy portability.

### BACKGROUND OF THE INVENTION

Conventional projection screens are mostly hanging constructions, each mostly comprising a roll, which is horizontally oriented and suspended on wall, a screen, rolled up on the roll, and a mechanism for rolling and unrolling the screen, which is driven manually or by a motor.

Such projection screens with large screens have high volumes and weights and are usually fixedly installed in classrooms or meeting rooms, without being portable as needed.

There are also portable screens, each of which commonly has a rollable screen and a height-adjustable frame. For opening the screen, the frame is vertically placed on the ground. When the screen is not used, the screen is detached from the frame, the screen is rolled up and the frame is shortened for transporting or storing.

Such portable screens can be transported, but have each two components, screen and frame, so that for each transportation two components have to be moved, which is cumbersome. Besides, a portable screen usually has an extendable rod for supporting the screen. Hence the screen, when unfolded, is supported only at one point, which has to be located at a horizontally central position to avoid inclining of the screen.

Recently, projectors have become widespread tools and the technology of small and portable projectors has made great progress, along with rising needs for projectors for business presentations. Consequently, demand for portability of screens has increased, which is less and less satisfied by conventional large screens and asks for small and light portable screens.

Available small and light projection screens each employ a single rod for supporting a screen after unfolding, but the screen is supported only at one central point, so that instability and inclining thereof happen easily.

Furthermore, projection screens that are not foldable, resembling A4 sheets of paper, have been developed. However, such unfoldable screens have fixed was which cannot be enlarged, so that requirements for functionality of screens are not satisfied, which is a severe shortcoming.

### SUMMARY OF THE INVENTION

The main object of the present invention is to provide a portable projection screen which is easily portable and light, having a rollable screen and a stable support system.

For achieving above objects, the present invention comprises a first frame, a second frame a screen, rolled up within the first frame in a folded state, having a movable end, which is attached to the second frame, and a lever assembly, having two levers which form a shape like the letter X (or double X) with fixed and glidable ends, supporting the second frame in an unfolded state and being accommodated in the first frame in the folded state for a minimized volume and easy portability.

The main effect of the present invention lies in the capability to unfold and support the screen without any further supporting frame, with the screen being stably supported and not swaying during use, and to fold the screen and the second frame completely into the first frame.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a front view of the portable projection screen of the present invention.

FIG. 2 is a front view of the portable projection screen of the present invention in an almost folded state.

FIG. 3 is a cross-sectional side view of the portable projection screen of the present invention in the folded state.

FIG. 4 is a cross-sectional side view of the portable projection screen of the present invention in the unfolded state.

FIG. 5 is a cross-sectional side view of the first frame of the present invention.

FIG. 6 is a cross-sectional side view of the second frame of the present invention.

FIG. 7 is a perspective view of the portable projection screen of the present invention in the unfolded state.

FIG. 8 is an enlarged top view of the fixing device of the present invention when mounted on the second frame.

FIG. 9 is top view of the fixing device of the present invention, when engaging with each other.

FIG. 10 is a front view of the portable projection screen of the present invention in the second embodiment, having first and second lever assemblies.

### DESCRIPTION OF THE PREFERRED EMBODIMENTS

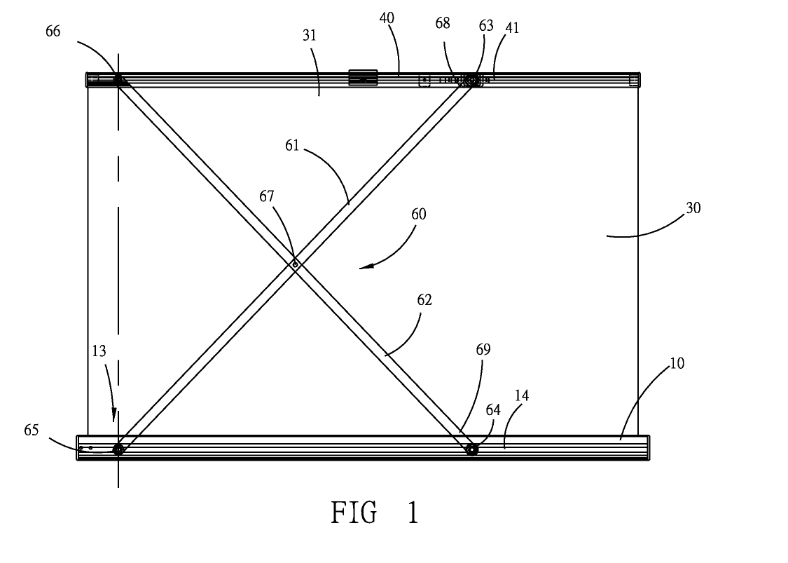

As shown in FIGS. 1-4, the portable projection screen of the present invention mainly comprises: a first frame 10; a mounting roll 20; a screen 30; a second frame 40; a foot stand group 50; and a lever assembly 60. The first frame 10 is horizontally oriented, made of light and stable aluminum and shaped like a hollow rod, having an interior 11. The mounting roll 20 is disposed along the first frame 10, placed within the interior 11 thereof and is rotatable around a longitudinal axis. The screen 30 has a lower edge, which is connected with the mounting roll 20, and an upper edge, which is a movable edge 31 and is connected with the second frame 40 along a longitudinal extension thereof.

The mounting roll 20 has a rolling spring (not shown). Unfolding the screen 30 drives the rolling spring. In an unfolded state of the screen 30, the rolling spring is fixed, storing elastic energy, which, for folding the screen 30, drives the screen 30 to be rolled on the mounting roll 20.

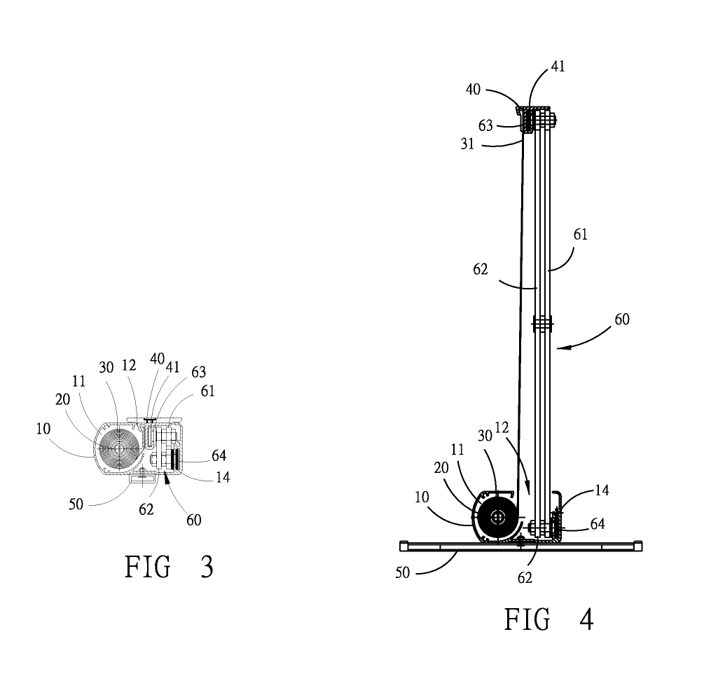

The second frame 40 is oriented parallel to the first frame 10 and being movable in a vertical direction, taking along the screen 30 upon unfolding or folding thereof. As shown in FIGS. 3 and 4, a longitudinal opening 12 is cut into the first frame 10, allowing the second frame 40 and the moving edge 31 of the screen 30 to pass through. When the screen 30 is completely folded on the mounting roll 20, the second frame 40 is completely accommodated by the longitudinal opening 12 of the first frame 10. For unfolding the screen 30, a user pulls the second frame 40 upwards, so that the screen 30 assumes the unfolded state thereof.

The foot stand group 50 provides support for the first frame 10 to be placed on the ground, oriented parallel to the ground. When the screen 30 is unfolded, the first frame thus rests on the ground or a table.

The main characteristic of the present invention is the lever assembly 60 between the first frame 10 and the second frame 40, allowing to move the second frame 40 vertically, while being oriented parallel to the first frame 10, and to hold the screen 30 in the unfolded state.

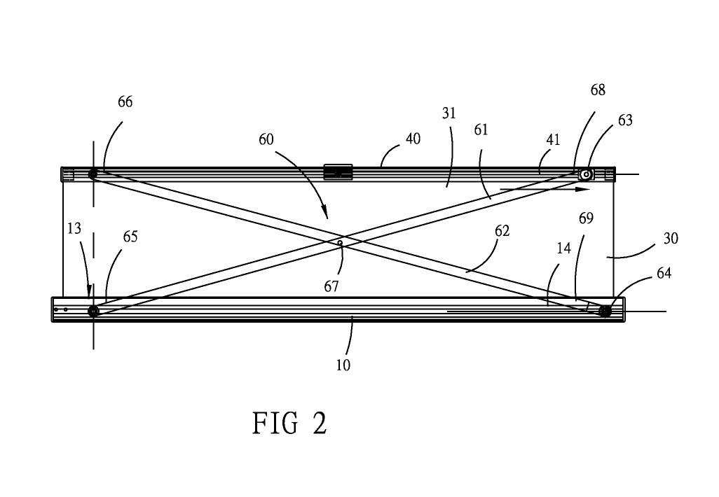

The lever assembly 60 is shaped like the letter X, having two levers 61, 62. The two levers 61, 62 are hingedly connected at central positions thereof by an axis 67. As shown in FIGS. 1 and 2, the two levers 61, 62 have fixed ends 65, 66, respectively, which are hingedly connected with the first and second frames 10, 40, respectively at a fixed horizontal position 13, Opposite thereto, the two levers 61, 62 have movable ends 68, 69, respectively, which are hingedly connected with the first and second frames 10, 40, respectively at a movable horizontal position.

Referring to FIG. 2, since the fixed ends 65, 66 of the two levers 61, 62 stay at the fixed horizontal position 13, when the second frame 40 is pulled up from the first frame 10, the fixed ends 65, 66 of the two levers 61, 62 will undergo a movement relative to each other along with the first and second frames 10, 40.

At that time, the central positions of the two levers 61, 62 coincide, as determined by the axis 67, so that the fixed ends 65, 66 of the two levers 61, 62 move against each other along with the first and second frames 10, 40. In the same way, the movable ends 68, 69 of the two levers 61, 62 undergo a relative movement that is symmetric to the relative movement of the fixed ends 65, 66 of the two levers 61, 62 with respect to the axis 67, so that the movable ends 68, 69 of the two levers 61, 62 stay in first and second guiding assemblies 14, 41 of the first and second frames 10, 40, respectively, parallelly gliding therein to drive the screen 30 to the unfolded state.

Referring again to FIG. 2, when the movable ends 68, 69 of the two levers 61, 62 in the first and second guiding assemblies 14, 41 move away from the fixed ends 65, 66 of the two levers 61, 62, a mutual distance of the first and second frames 10, 40 decreases. When the two levers 61, 62 have moved to a position of coinciding with each other, the second frame 40 is accommodated by the first frame 10 and the screen 30 is completely rolled up within the first frame 10 (as shown in FIG. 4).

On the other hand, when the movable ends 68, 69 of the two levers 61, 62 in the first and second guiding assemblies 14, 41 move towards the fixed ends 65, 66 of the two levers 61, 62, the lever assembly 60 rises and a mutual distance of the first and second frames 10, 40 increases, so that the screen 30 is unfolded (as shown in FIGS. 1-4).

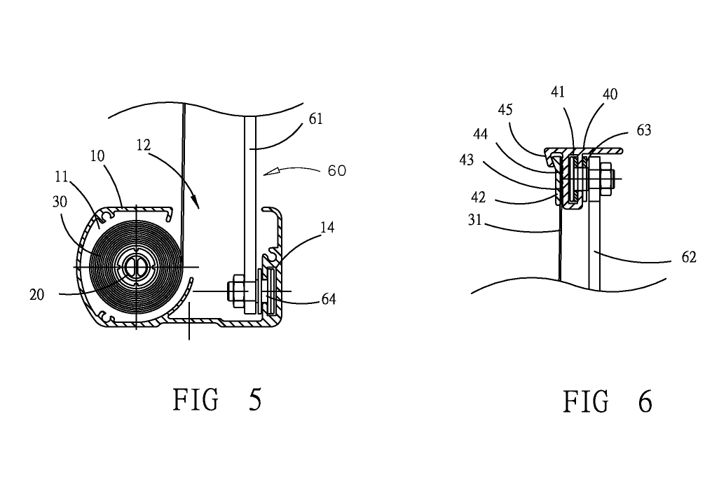

Referring to FIGS. 5, 6 and 7, the first guiding assembly 14 is mounted on one lateral side of the interior 11 of the first frame 10, extending along the longitudinal direction thereof. A first connecting element 64 is mounted on the movable end 69 of the lever 62, gliding along the first guiding assembly 14. Similarly, the second guiding assembly 41 is mounted on a rear side of the second frame 40, extending along the longitudinal direction thereof. A second connecting element 63 is mounted on the movable end 68 of the lever 61, gliding along the second guiding assembly 41. En the embodiment shown, the first and second guiding assemblies 14, 41 are shaped like grooves, each having one open side, with the first and second connecting elements 63, 64 respectively inserted therein, being gliding pieces or rolls. Thus the movable ends 68, 69 of the two levers 61, 62 are restricted to moving along the longitudinal directions of the first and second frames 10, 40, respectively.

As shown in FIG. 7, when the movable ends 68, 69 of the two levers 61, 62 have reached extreme unfolding positions, the screen 30 is completely unfolded. The lever assembly 60 ensures that the screen 30 is held along the moving edge thereof and kept in a stable position for projecting.

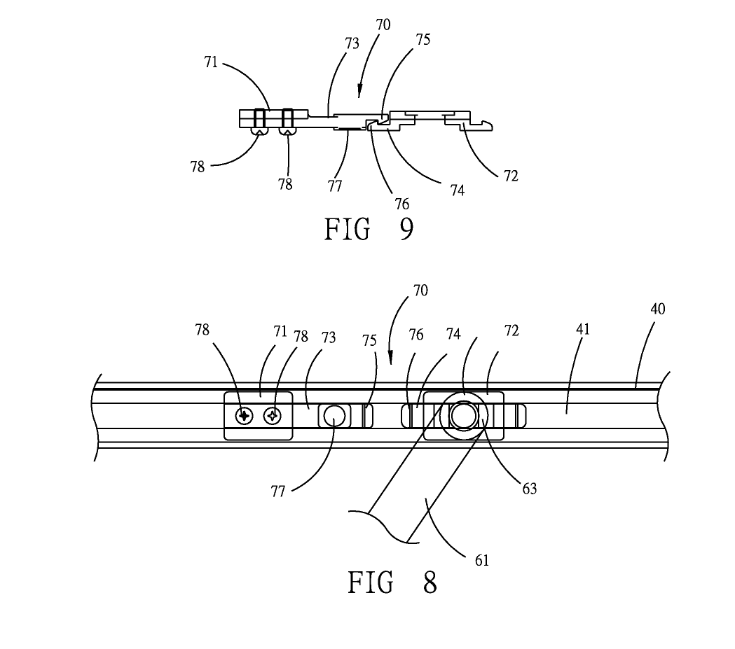

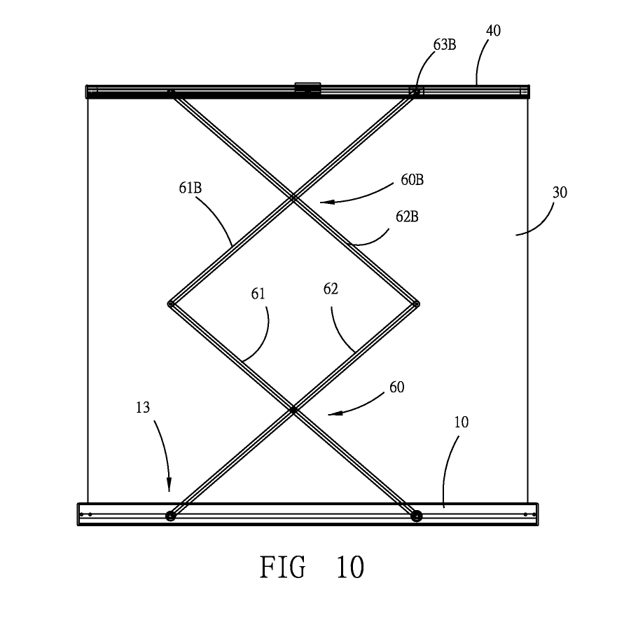

The second frame 40 is further provided with a fixing device 70 for fixing the lever assembly 60 in the unfolded state of the screen 30. As shown in FIGS. 8 and 9, the fixing device 70 comprises: a fixed base 71, mounted in the second guiding assembly 41 of the second frame 40, and a gliding base 72, connected with the movable end 68 of the lever 61. The fixed base 71 is fastened at a position close to the extreme unfolding position of the lever 61, so that, when the lever assembly 60 has risen to an uppermost position thereof and the screen 30 is in the unfolded state, the gliding base 72 has approached the fixed base 71.

Referring to FIG. 9, the fixed base 71 and the gliding base 72 at ends that face each other have first and second holding elements 73, 74. The first and second holding elements 73, 74 have hooks 75, 76. When the first and second holding elements 73, 74 of the fixed base 71 and the gliding base 72 glide over each other, the hooks 75, 76 engage, so that the movable end 68 of the lever 61 is held at the extreme unfolding position thereof.

The fixed base 71 is mountable at any longitudinal position on the second guiding assembly 41 to adjust an unfolded height of the screen 30. For raising the unfolded height of the screen 30, the fixed base 71 is shifted towards the fixed end 66 and then fastened by fastening elements 78 (for example, bolts).

A pressing part 77 is mounted on the first holding element 73 or the second holding element 74. Manual pressing on the pressing part 77, causes the first or second holding elements 73, 74 to bend, so that the hooks 75, 76 disengage from each other, allowing the gliding base 72 with the movable end 68 of the lever 61 of the lever assembly 60 to move freely to fold up the lever assembly 60 and the second frame 40.

The fixed base 71 and the gliding base 72 of the fixing device 70 are respectively placed at the second frame 40 and the movable end 68 of the lever 61. However, alternatively, the fixed base 71 and the gliding base 72 of the fixing device 70 are respectively placed at the first frame 10 and the movable end 69 of the lever 62, with the same effect.

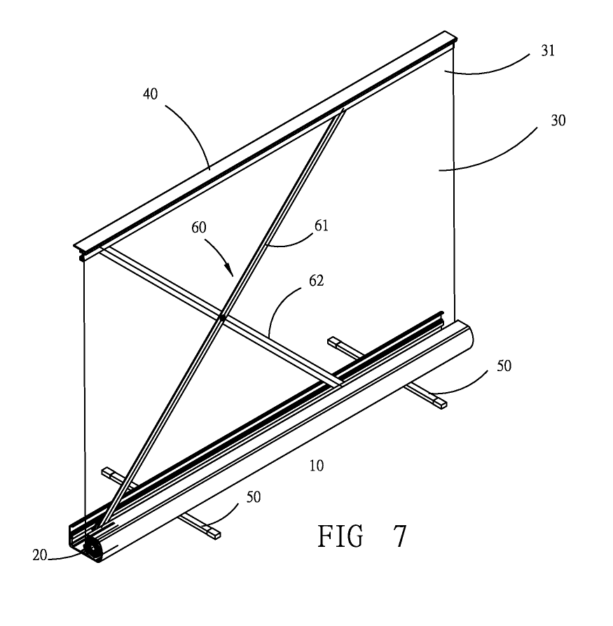

A further advantage offered by the present invention is a way of combining of the screen 30 and the second frame 40, wherein, after combining of the screen 30 and the second frame 40, the screen 30 will be flatly extended after unfolding. As shown in FIG. 6, the second frame 40 has a front side with a front plate 43, to which the movable end 31 of the screen 30 is attached. A plurality of teeth-like threads 44 project from a front side of the front plate 43, increasing friction between the movable end 31 and the front plate 43. On an upper edge of the front plate 43, a clasping plate 45 is placed, which extends forward beyond the front side of the front plate 43 and is subsequently bent downwards.

The movable end 31 of the screen 30 is fastened by gluing thereof on a holding plate 42, using a heat-resistant double-sided gluing means. Then the holding plate 42 with the movable end 31 of the screen 30 is horizontally inserted into the clasping plate 45. When the screen 30 is unfolded, the rolling spring on the roll 20 exerts an elastic downward force. The downward force causes an inclined upper surface of the holding plate 42 and the clasping plate 45 to engage, holding the screen 30 in a gap against the front plate 43, while the threads 44 engage with the screen 30, not allowing the screen 30 to slip out, so that the object of a stable hold of the screen 30 is achieved and the screen 30 is unfolded as a flat plane.

Referring to FIG. 10, in a second embodiment of the present invention, at least one lever assembly 60 is disposed between the first and second frames 10, 40, allowing to increase the mutual distance of the first and second frames 10, 40 in the unfolded state. Thus the present invention becomes applicable to larger screens.

As shown in FIG. 10, a second lever assembly 60B is additionally disposed between the first and second frames 10, 40. The second lever assembly 60B, like the lever assembly 60, is shaped like the letter X, connecting the lever assembly 60 and the second frame 40. The second lever assembly 60B has two levers 61B, 62B. The two levers 61B, 62B are hingedly connected at central positions thereof. The lever 62B is at a fixed end thereof hingedly connected with the second frame 40 at the fixed horizontal position 13. The lever 61B has a movable end with a connecting element which glides in the second guiding assembly 41 of the second frame 40.

The portable projection screen of the present invention, in comparison with a conventional projection screen, provides the lever assembly 60 for supporting the unfolded screen. Hence no extra frame is required to unfold the screen. Furthermore, after folding the screen 30, the lever assembly 60 is completely accommodated by the first frame 10, so that volume is minimized and portability is ensured. The lever assembly 60 has town levers 61, 62, which are shaped like the letter X, so that, in the unfolded state, the second frame 40 is stably supported and will not sway during usage.

Furthermore, the present invention allows to modify the lengths of the first and second frames 10, 40 according to user requirements. Accordingly, the levers 61, 62 are producible with various lengths to meet various needs of the market.

While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A portable projection screen, comprising:
a first frame, having an interior housing a roll, and comprising a footing unit to support said frame on a horizontal surface;
a projection screen, having one end connected with said roll and rolled up on said roll and having another end which is a movable end; and
a second frame, perpendicularly connected with said movable end of said screen and movable upward and downward, while being oriented parallel to said first frame, taking along said screen for obtaining an unfolded state or rolled-up state;
characterized in that
a lever assembly is mounted between said first frame and said second frame, having two levers, which are hingedly connected at central locations thereof, said two levers forming a shape like the letter X, with respectively one end being a fixed end, which is hingedly connected with said first and second frames, respectively, and respectively another end being a movable end, which is connected between said first and second frames, glidingly movable longitudinally within said first and second frames respectively;
wherein said two levers of said lever assembly connect said first and second frames and wherein, when in said unfolded state of said screen, said first and second frames are firmly placed opposite to each other, securing said screen in said unfolded state;
and wherein said screen is without any further supporting frame.

2. The portable projection screen of claim 1, wherein a first guiding assembly is mounted on said first frame, a second guiding assembly is mounted on said second frame, said two levers of said lever assembly at said movable ends thereof have first and second connecting elements, respectively, guiding said movable ends of said two levers linearly within said first and second frames.

3. The portable projection screen of claim 2, wherein a first and second guiding assemblies are shaped like grooves with longitudinal openings and said first and second connecting elements are gliding pieces or rolls, held within said first and second guiding assemblies.

4. The portable projection screen of claim 3. wherein between said lever assembly and said second frame a second lever assembly is mounted, having two levers, which are of equal lengths as said levers, forming a shape like the letter X, with said levers at ends that approach each other being hingedly connected with each other and at ends that approach said first and second frames being hingedly or glidingly connected with said first and second frames, so that said first and second frames are kept parallel to each other in said folded state and said unfolded state.

5. The portable projection screen of claim 1, wherein said second frame has a front plate for attaching said movable end of said screen, a holding plate to which said movable end is glued and which is movable against said front plate, and a clasping plate, disposed on an edge of said front, late and pressing said holding plate against said front plate.

6. The portable projection screen of claim 5, wherein said front plate further has a plurality of threads for increasing friction with said screen.

7. The portable projection screen of claim 1, wherein said lever assembly further has a fixing device, which comprises a fixed base, mounted in said first frame or second frame, and a gliding base, connected with one of said levers of said lever assembly at said movable end thereof, wherein said fixed base is placed at a position close to one end of one of said levers in said unfolded state, so that, in said unfolded state, said gliding base at a second holding element thereof engages with said fixed base at a first holding element thereof.
